(19) United States
(12) Patent Application Publication
(10) Pub. No.: US 2014/0083953 A1
(43) Pub. Date: Mar. 27, 2014

(54) COMPOSITION AND METHOD FOR REMOVING EXCESS FORMALDEHYDE

(71) Applicant: Charles E. Coburn, Vernon Hills, IL (US)

(72) Inventor: Charles E. Coburn, Vernon Hills, IL (US)

(73) Assignee: ANGUS CHEMICAL COMPANY, Buffalo Grove, IL (US)

(21) Appl. No.: 14/115,646

(22) PCT Filed: May 17, 2012
(86) PCT No.: PCT/US2012/038290

§ 371 Date: Nov. 5, 2013

Related U.S. Application Data
(60) Provisional application No. 61/494,925, filed on Jun. 9, 2011.

(51) Int. Cl. C02F 1/72

(52) U.S. Cl. CPC C02F 1/72
USPC 210/758; 252/180

(57) ABSTRACT

Provided are compositions and methods for removing excess formaldehyde from aqueous systems. The compositions comprise: a hydroxylamine compound of formula I: OH I R—N—H (I) wherein R is as defined herein; and an activated olefm.

### CROSS-REFERENCE TO RELATED APPLICATIONS

This application claims priority from provisional application Ser. No. 61/494,925, filed Jun. 9, 2011, which is incorporated herein by reference in its entirety.

### BACKGROUND

This invention relates generally to compositions and methods for removing excess formaldehyde from an aqueous system.

Many industrial processes use formaldehyde as a co-reactant or form formaldehyde as a byproduct. It is often advantageous to remove the excess formaldehyde at the end of the process. This is desirable because formaldehyde is a reactive material that may interfere with subsequent processing steps. Formaldehyde also has a strong odor that may interfere with the aesthetic appeal of products. In addition, concerns over the potential effects of formaldehyde on health have resulted in close regulations of the material in many environments.

In the leather industry, synthetic tannins (syntans) are a set of chemicals that combine with, or affect, the protein constituents of hides and skins and produce a product that is flexible, porous, and has the desirable qualities of leather. Many syntans are made by treating aromatic substances, e.g., cresols, phenols, naphthalenes, etc., with formaldehyde and sulfuric acid. However, at the end of this process, some residual formaldehyde remains in the product. It is highly desirable to remove the residual formaldehyde content.

The problem addressed by this invention is the provision of compositions and methods for removing excess formaldehyde from aqueous systems.

### STATEMENT OF INVENTION

We have now found that compositions containing hydroxylamine compound and an active olefin compound are highly effective at removing excess formaldehyde from aqueous systems. Advantageously, in some embodiments, the composition may remove 99 percent of the free formaldehyde from the system.

Accordingly, in one aspect, there is provided a process for removing excess formaldehyde from an aqueous system, the process comprising contacting the aqueous system with:

a hydroxylamine compound of formula I:

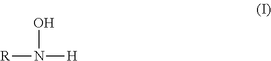

wherein R is C₁-C₈ alkyl, or C₃-C₁₂ cycloalkyl; and

an activated olefin.

In another aspect, there is provided a composition comprising:

a hydroxylamine compound of formula I:

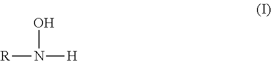

wherein R is C₁-C₈ alkyl, or C₃-C₁₂ cycloalkyl; and

an activated olefin.

### DETAILED DESCRIPTION

Unless otherwise indicated, numeric ranges, for instance as in “from 2 to 10,” are inclusive of the numbers defining the range (e.g., 2 and 10).

Unless otherwise indicated, ratios, percentages, parts, and the like are by weight.

In some embodiments, R in the hydroxylamine compound of formula I is C₁-C₈ alkyl. “Alkyl” as used in this specification encompasses straight and branched chain aliphatic groups having the indicated number of carbon atoms. In some embodiments, alkyl contains 1-6 carbon atoms (C₁-C₆ alkyl), alternatively 1 to 4 carbon atoms (C₁-C₄ alkyl). Preferred alkyl groups include, without limitation, methyl, ethyl, propyl, isopropyl, butyl, isobutyl, sec-butyl, tert-butyl, pentyl, and hexyl.

In some embodiments, R in the hydroxylamine compound of formula I is C₃-C₁₂ cycloalkyl. The term “cycloalkyl” refers to saturated and partially unsaturated cyclic hydrocarbon groups having the indicated number of ring carbon atoms. Preferred cycloalkyl contains from 3 to 8 carbons, and more preferably from 3 to 7 carbons. Preferred cycloalkyl groups include, without limitation, cyclopropyl, cyclobutyl, cyclopentyl, cyclopentenyl, cyclohexyl, cyclohexenyl, cycloheptyl, and cyclooctyl. Unless otherwise indicated, the cycloalkyl group is optionally substituted with 1, 2, or 3, preferably 1 or 2, more preferably 1, substituents independently selected C₁-C₆ alkyl.

In some embodiments, the hydroxylamine compound of formula I is methylhydroxylamine, ethylhydroxylamine, n-propylhydroxylamine, isopropylhydroxylamine, t-butylhydroxylamine, or cyclohexylhydroxylamine. In a preferred embodiment, the compound is isopropylhydroxylamine.

In some embodiments, the activated olefin of the composition is a compound that comprises an olefin with at least one electron withdrawing group bonded to an olefinically unsaturated carbon atom. In some embodiments, the activated olefin is maleic acid, cinnamic acid, methyl methacrylate, dimethyl maleate, methyl acrylate, or methyl cinnamate.

In some embodiments, the activated olefin is styrene.

In some embodiments of the compositions and methods of the invention, the hydroxylamine compound is isopropylhydroxylamine and the activated olefin is styrene.

In some embodiments of the compositions and methods of the invention, the hydroxylamine compound is cyclohexylhydroxylamine and the activated olefin is styrene.

In some embodiments, the mole ratio of hydroxylamine of formula Ito activated olefin in the composition is from 2:1 to 0.5:1. In some embodiments, a slight molar excess of hydroxylamine is used, such as a ratio of 1.1:1.

As noted above, the compositions of the invention are useful for removing formaldehyde from aqueous systems. By “removing” as used in this context is meant that the concentration of free formaldehyde in the system is reduced following treatment with the inventive composition. In some embodiments, removing means that the free formaldehyde content is reduced by at least 50 weight percent, alternatively by at least 60 weight percent, alternatively by at least 70 weight percent, alternatively by at least 80 weight percent, alternatively by at least 90 weight percent, or alternatively by at least 99 weight percent, relative to the concentration prior to treatment with the composition.

The hydroxylamine and activated olefin may be mixed together prior to addition to the aqueous system, or they may be added separately, e.g., the hydroxylamine added first, followed by the activated olefin, or the activated olefin added first, followed by the hydroxylamine. In addition, the components or composition may be delivered neat or may be dissolved or dispersed in a solvent. The amount of the composition to use will depend on how much formaldehyde is present in the system under treatment and the level of formaldehyde reduction that is desired. A person of ordinary skill in the art can readily determine such quantities without undue experimentation. In some embodiments, it is desirable to measure the amount of formaldehyde in the system and then add at least 1, preferably greater than 1, preferably greater than 1.2, molar equiavents of the hydroxylamine and the olefin (relative to the formaldehyde) to the system and allow sufficient time (e.g., 1-24 hours) for the formaldehyde reduction to occur. In some embodiments, it may be desirable heat the system to further facilitate the formaldehyde reduction.

The compositions of the invention may be used for removing formaldehyde from a variety of aqueous systems. In some preferred embodiments, the compositions are used with aqueous systems in the leather industry. In further preferred embodiments, the compositions are used for the removal of excess formaldehyde from syntans. In a typical procedure, the waste syntan is pumped into a storage tank, which may be heated (e.g., 50 to 75° C.), and the amount of free formaldehyde measured and the total amount (wt) of formaldehyde determined. To this stirred waste syntan is added the hydroxylamine at about a 1.2 molar ratio relative to the followed by the olefin at about a 1.1 molar ratio relative to the formaldehyde. The mixture may be maintained in the heated tank until the level of residual formaldehyde is reduced to acceptable levels, e.g, 1-4 hours. Additional amounts of hydroxylamine and olefin may be added to aid in the reduction of the free formaldehyde. In some embodiments, it is preferable to conduct the addition of the hydroxylamine and olefin stirring of the mixture under an inert atmosphere, such as nitrogen.

Some embodiments of the invention will now be described in detail in the following Examples.

### EXAMPLES

In the examples below, free formaldehyde in a sample is determined by titration. In a typical procedure, a known amount of hydroxylammonium chloride is added to the sample, which reacts with free formaldehyde liberating mole for mole hydrochloric acid that is then titrated with NaOH. Knowing the number of moles of NaOH needed indicates the number of moles of the hydroxylammonium chloride that reacted with the same number of moles of formaldehyde in the sample originally. An Autotitrator 888 Titrando may be used for the analysis.

### Example 1

An experiment is run using an aqueous solution of formaldehyde (2000 ppm) and treating a portion of it with either isopropylhydroxylamine (IPHA) alone (3 times weight) or with a combination of IPHA (3 times weight) and styrene (4 times weight). Reacting it 75° C. for 2 hours results, as measured by titration, in 400 ppm of free formaldehyde with IPHA (80% reduction) or 200 ppm of formaldehyde using IPHA and styrene (90% reduction).

### Example 2

In a similar fashion to example 1, a stock solution of aqueous formaldehyde (1756 ppm) is prepared and placed into 6 separate glass vials. To each vial is added a primary hydroxylamine (1.25 molar equivalence) selected from the structures below and then styrene (1.25 molar equivalence). The vials are sealed and placed into a 70° C. water bath for 2 hours during which time they are shaken twice. The samples are removed, cooled, and analyzed for their residual formaldehyde as shown in Table 1 below.

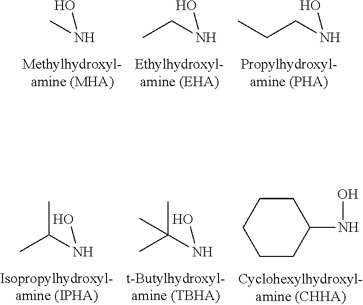

TABLE 1
The Formaldehyde Analysis of the Hydroxylamine/Styrene
Treated Solutions

| | Hydroxyl- | Initial | Final | % |
|---|---|---|---|---|
| Run | amine | Formaldehyde | Formaldehyde | Formaldehyde |
| No. | Studied | Conc. Measured | Conc. Measured | Reduction |
| 1 | MHA | 1756 | 815 | 54 |
| 2 | EHA | 1756 | 107 | 94 |
| 3 | PHA | 1756 | 99 | 94 |
| 4 | IPHA | 1756 | 163 | 91 |
| 5 | TBHA | 1756 | 101 | 94 |
| 6 | CHHA | 1756 | N/D | >99 |

N/D = Not detected.

1. A process for removing excess formaldehyde from an aqueous system, the process comprising contacting the aqueous system with:
a hydroxylamine compound of formula I: 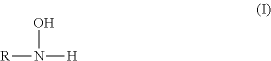
wherein R is C₁-C₈ alkyl, or C₃-C₁₂ cycloalkyl; and
an activated olefin.

2. The process of claim 1 wherein the activated olefin comprises an olefin with at least one electron withdrawing group bonded to an olefinically unsaturated carbon atom.

3. The process of claim 1 wherein the activated olefin is maleic acid, cinnamic acid, methyl methacrylate, dimethyl maleate, methyl acrylate, or methyl cinnamate.

4. The process of claim 1 wherein the activated olefin is styrene.

5. The process of claim 1 wherein R is C₁-C₆ alkyl or C₄-C₇ cycloalkyl.

6. The process or claim 1 wherein the hydroxylamine compound of formula I is methylhydroxylamine, ethylhydroxylamine, n-propylhydroxylamine, isopropylhydroxylamine, t-butylhydroxylamine, or cyclohexylhydroxylamine.

7. The process of claim 1 wherein the aqueous system is contacted with the hydroxylamine compound of formula I and the activated olefin at the same time.

8. The process of claim 1 wherein the aqueous system comprises synthetic tannins.

9. A composition comprising:
a hydroxylamine compound of formula I: 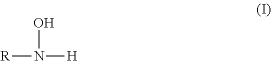
wherein R is C₁-C₈ alkyl, or C₃-C₁₂ cycloalkyl; and
an activated olefin.

10. The composition of claim 9 wherein the activated olefin is styrene.

11. The composition of claim 9 wherein the activated olefin comprises an olefin with at least one electron withdrawing group bonded to an olefinically unsaturated carbon atom.

12. The composition of claim 9 wherein the activated olefin is maleic acid, cinnamic acid, methyl methacrylate, dimethyl maleate, methyl acrylate, or methyl cinnamate.

13. The composition of claim 9 wherein R is C₁-C₆ alkyl or C₄-C₇ cycloalkyl.

14. The composition of claim 9 wherein the hydroxylamine compound of formula I is methylhydroxylamine, ethylhydroxylamine, n-propylhydroxylamine, isopropylhydroxylamine, t-butylhydroxylamine, or cyclohexylhydroxylamine.
